(19) United States
(12) Patent Application Publication
(10) Pub. No.: US 2008/0293449 A1
(43) Pub. Date: Nov. 27, 2008

(54) METHOD AND SYSTEM FOR PARTITIONING A DEVICE INTO DOMAINS TO OPTIMIZE POWER CONSUMPTION

(76) Inventors: Stephen Barlow, Cambridge (GB); Nick Lambourne, Stoke on Trent (GB)

Correspondence Address: MCANDREWS HELD & MALLOY, LTD, 500 WEST MADISON STREET, SUITE 3400, CHICAGO, IL, 60661, US

(21) Appl. No.: 11/933,851

(22) Filed: Nov. 1, 2007

Related U.S. Application Data
(60) Provisional application No. 60/939,904, filed on May 24, 2007.

(51) Int. Cl. H04M 1/02

(52) U.S. Cl. 455/556.1; 455/574

(57) ABSTRACT

Methods and systems for partitioning a device to optimize power consumption are disclosed and may include partitioning circuitry within an integrated circuit into a plurality of power domains, wherein each of the domains includes different power consumption and handling requirements and a processor. A processor in one of the domains may handle processing of tasks internal to that domain. A processor in the first domain may handle processing of tasks in a second of the domains. The processor in each of the domains may be communicatively coupled to one or more common busses, which may be shared by each of the domains. One domain may be powered in a continuous mode and may include low leakage circuitry. The processors may include general purpose processors. A processor in one domain may control image processing circuitry, which may comprise image sensor pipeline, 3D pipeline and/or video accelerator circuitry.

### CROSS-REFERENCE TO RELATED APPLICATIONS/INCORPORATION BY REFERENCE

This application makes reference to and claims priority to U.S. Provisional Application Ser. No. 60/939,904, filed on May 24, 2007, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to data processing. More specifically, certain embodiments of the invention relate to a method and system for partitioning a device into domains to optimize power consumption.

### BACKGROUND OF THE INVENTION

Cellular phones have developed from large, expensive devices typically used only in cars and owned only by a small percentage of the population to miniature, inexpensive, and ubiquitous handheld devices, and are even more numerous than traditional land-line phones in countries with poor fixed-line infrastructure. Cellular handsets have incorporated text messaging, email, connection to the Internet, PDAs, and even personal computers.

Cellular phones with built-in cameras, or camera phones, have become prevalent in the mobile phone market, due to the low cost of CMOS image sensors and the ever increasing customer demand for more advanced cellular phones. As camera phones have become more widespread, their usefulness has been demonstrated in many applications, such as casual photography, but have also been utilized in more serious applications such as crime prevention, recording crimes as they occur, and news reporting.

Historically, the resolution of camera phones has been limited in comparison to typical digital cameras, due to the fact that they must be integrated into the small package of a cellular handset, limiting both the image sensor and lens size. In addition, because of the stringent power requirements of cellular handsets, large image sensors with advanced processing have been difficult to incorporate. However, due to advancements in image sensors, multimedia processors, and lens technology, the resolution of camera phones has steadily improved rivaling that of many digital cameras.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for partitioning a device into domains to optimize power consumption, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary mobile multimedia system, in accordance with an embodiment of the invention.

FIG. 1B is a block diagram of an exemplary mobile multimedia processor, in accordance with an embodiment of the invention.

FIG. 2 is a block diagram of two vector processing units in different partitions on a chip, in accordance with an embodiment of the invention.

FIG. 3 is a block diagram illustrating an image sensor pipeline implementation process, in accordance with an embodiment of the invention.

FIG. 4 is a block diagram of a 3D pipeline implementation process, in accordance with an embodiment of the invention.

### DETAILED DESCRIPTION OF THE INVENTION

Certain aspects of the invention may be found in a method and system for partitioning a device into domains to optimize power consumption. Exemplary aspects of the invention may comprise partitioning circuitry within an integrated circuit into a plurality of power domains, wherein each of the power domains may comprise different power consumption and power handling requirements and each of the power domains may comprise a processor. A processor in a first of the power domains may handle processing of tasks internal to the first of the power domains. A processor in the first of the power domains may handle processing of tasks in a second of the plurality of power domains. The processor in each of the plurality of power domains may be communicatively coupled to one or more common busses which may be shared by each of the plurality of power domains. A first of the power domains may be powered in a continuous mode and may comprise low leakage circuitry. The processors may comprise general purpose processors. A processor in one of the plurality of power domains may control image processing circuitry, which may comprise image sensor pipeline circuitry, 3D pipeline circuitry and/or video accelerator circuitry.

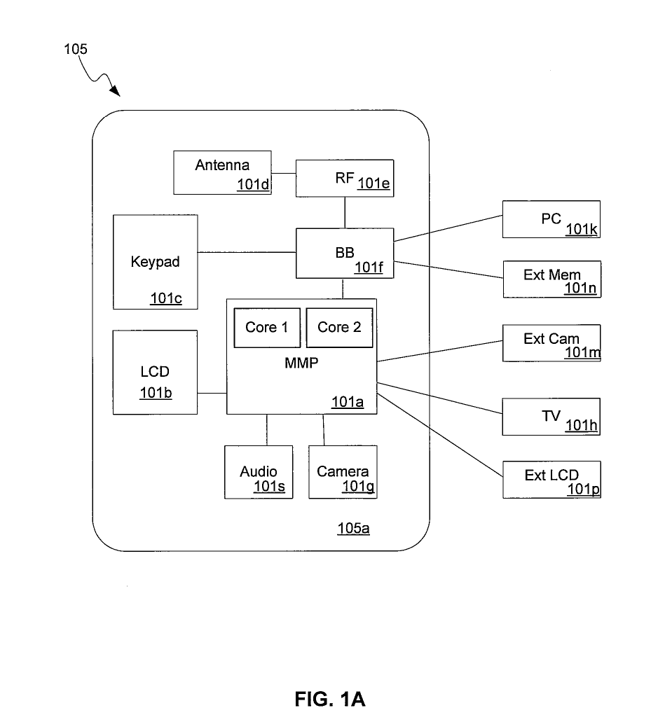

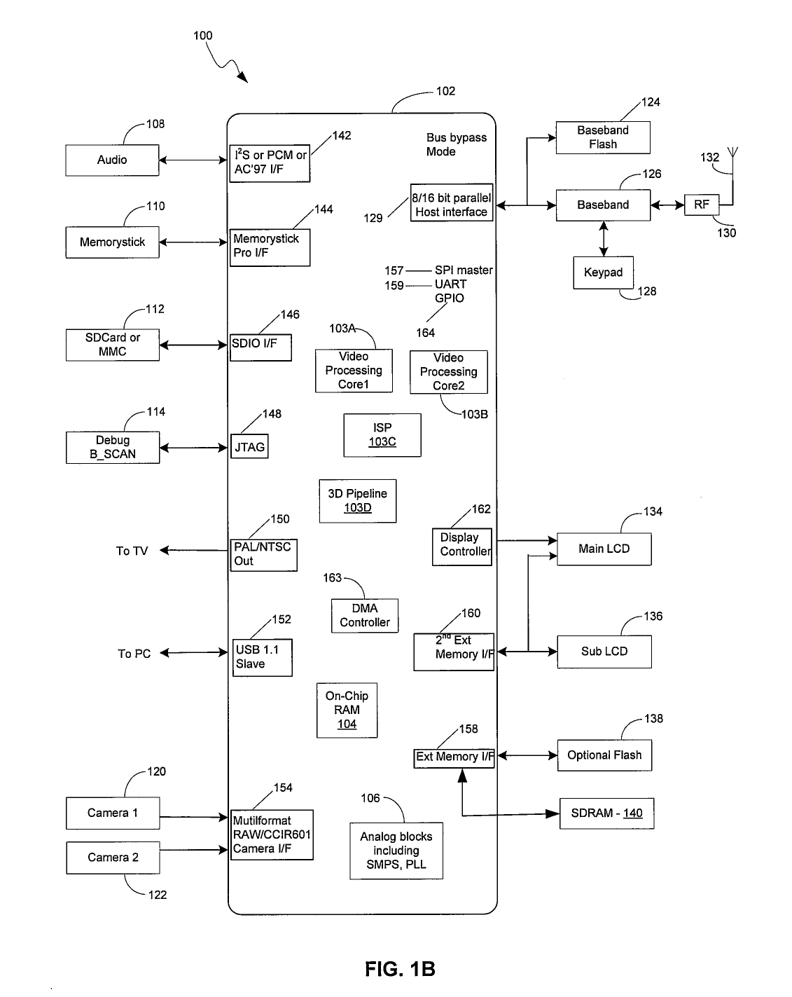

FIG. 1A is a block diagram of an exemplary mobile multimedia system, in accordance with an embodiment of the invention. Referring to FIG. 1A, there is shown a mobile multimedia system 105 that comprises a mobile multimedia device 105a, a TV 101h, a PC 101k, an external camera 101m, external memory 101n, and external LCD display 101p. The mobile multimedia device 105a may be a cellular telephone or other handheld communication device. The mobile multimedia device 105a may comprise a mobile multimedia processor (MMP) 101a, an antenna 101d, an audio block 101s, a radio frequency (RF) block 101e, a baseband processing block 101f, an LCD display 101b, a keypad 101c, and a camera 101g.

The MMP 101a may comprise suitable circuitry, logic, and/or code and may be adapted to perform video and/or multimedia processing for the mobile multimedia device 105a. The MMP 101a may further comprise a plurality of processor cores, indicated in FIG. 1A by Core 1 and Core 2. The MMP 101a may also comprise integrated interfaces, which may be utilized to support one or more external devices coupled to the mobile multimedia device 105a. For example, the MMP 101a may support connections to a TV 101h, an external camera 101m, and an external LCD display 101p.

In operation, the mobile multimedia device may receive signals via the antenna 101d. Received signals may be processed by the RF block 101e and the RF signals may be converted to baseband by the baseband processing block 101f. Baseband signals may then be processed by the MMP 101a. Audio and/or video data may be received from the external camera 101m, and image data may be received via the integrated camera 101g. During processing, the MMP 101a may utilize the external memory 101n for storing of processed data. Processed audio data may be communicated to the audio block 101s and processed video data may be communicated to the LCD 101b and/or the external LCD 101p, for example. The keypad 101c may be utilized for communicating processing commands and/or other data, which may be required for audio or video data processing by the MMP 101a.

The separate cores of the MMP 101a may be integrated on a single chip, and may be located in separate regions of the chip, with devices that may be enabled for particular functions or processes. For example, a higher percentage of high threshold CMOS transistors may be located in one region for lower leakage current, and a higher percentage of lower threshold voltage CMOS transistors may reside in other regions, for higher speed applications. In this manner, speed and power usage may be tuned for particular applications or processes.

FIG. 1B is a block diagram of an exemplary mobile multimedia processor, in accordance with an embodiment of the invention. Referring to FIG. 1B, the mobile multimedia processor 102 may comprise suitable logic, circuitry and/or code that may be adapted to perform video and/or multimedia processing for handheld multimedia products. For example, the mobile multimedia processor 102 may be designed and optimized for video record/playback, mobile TV and 3D mobile gaming, utilizing integrated peripherals and a video processing core. The mobile multimedia processor 102 may comprise video processing cores 103A and 103B, an image sensor pipeline (ISP) 103C, a 3D pipeline 103D, on-chip RAM 104, an analog block 106, a direct memory access (DMA) controller 163, an audio interface (I/F) 142, a memory stick I/F 144, SD card I/F 146, JTAG I/F 148, TV output I/F 150, USB I/F 152, a camera I/F 154, and a host I/F 129. The mobile multimedia processor 102 may further comprise a serial peripheral interface (SPI) 157, a universal asynchronous receiver/transmitter (UART) I/F 159, general purpose input/output (GPIO) pins 164, a display controller 162, an external memory I/F 158, and a second external memory I/F 160.

The video processing cores 103A and 103B may comprise suitable circuitry, logic, and/or code and may be adapted to perform video processing of data. The on-chip RAM 104 and the SDRAM 140 comprise suitable logic, circuitry and/or code that may be adapted to store data such as image or video data.

The image sensor pipeline (ISP) 103C may comprise suitable circuitry, logic and/or code that may enable the processing of image data. The ISP 103C may perform a plurality of processing techniques comprising filtering, demosaic, lens shading correction, defective pixel correction, white balance, image compensation, Bayer interpolation, color transformation, and post filtering, for example. The processing of image data may be performed on variable sized tiles, reducing the memory requirements of the ISP 103C processes.

The 3D pipeline 103D may comprise suitable circuitry, logic and/or code that may enable the rendering of 2D and 3D graphics. The 3D pipeline 103D may perform a plurality of processing techniques comprising vertex processing, rasterizing, early-Z culling, interpolation, texture lookups, pixel shading, depth test, stencil operations and color blend, for example.

The analog block 106 may comprise a switch mode power supply (SMPS) block and a phase locked loop (PLL) block. In addition, the analog block 106 may comprise an on-chip SMPS controller, which may be adapted to generate its core voltage. The core voltage may be software programmable according to, for example, speed demands on the mobile multimedia processor 102, allowing further control of power management.

The analog block 106 may also comprise a plurality of PLL's that may be adapted to generate about 195 kHz-200 MHz clocks, for example, for external devices. Other voltages and clock speeds may be utilized depending on the type of application. The mobile multimedia processor 102 may comprise a plurality of power modes of operation, for example, run, sleep, hibernate and power down.

The audio block 108 may comprise suitable logic, circuitry and/or code that may be adapted to communicate with the mobile multimedia processor 102 via an inter-IC sound (I²S), pulse code modulation (PCM) or audio codec (AC'97) interface 142 or other suitable interface, for example. In the case of an AC'97 and/or an I²S interface, suitable audio controller, processor and/or circuitry may be adapted to provide AC'97 and/or I²S audio output respectively, in either master or slave mode. In the case of the PCM interface, a suitable audio controller, processor and/or circuitry may be adapted to allow input and output of telephony or high quality stereo audio. The PCM audio controller, processor and/or circuitry may comprise independent transmit and receive first in first out (FIFO) buffers and may use DMA to further reduce processor overhead. The audio block 108 may also comprise an audio in, audio out port and a speaker/microphone port (not illustrated in FIG. 1B).

The mobile multimedia device 100 may comprise at least one portable memory input/output (I/O) block. In this regard, the memorystick block 110 may comprise suitable logic, circuitry and/or code that may be adapted to communicate with the mobile multimedia processor 102 via a memorystick pro interface 144, for example. The SD card block 112 may comprise suitable logic, circuitry and/or code that may be adapted to communicate with the mobile multimedia processor 102 via a SD input/output (I/O) interface 146, for example. A multimedia card (MMC) may also be utilized to communicate with the mobile multimedia processor 102 via the SD input/output (I/O) interface 146, for example. The mobile multimedia device 100 may comprise other portable memory I/O blocks such an xD I/O card.

The debug block 114 may comprise suitable logic, circuitry and/or code that may be adapted to communicate with the mobile multimedia processor 102 via a joint test action group (JTAG) interface 148, for example. The debug block 114 may be adapted to access the address space of the mobile multimedia processor 102 and may be adapted to perform boundary scan via an emulation interface. Other test access ports (TAPs) may be utilized. The phase alternate line (PAL)/national television standards committee (NTSC) TV output I/F 150 may be utilized for communication with a TV, and the universal serial bus (USB) 1.1, or other variant thereof, slave port I/F 152 may be utilized for communications with a PC, for example. The cameras 120 and/or 122 may comprise suitable logic, circuitry and/or code that may be adapted to communicate with the mobile multimedia processor 102 via a multiformat raw/CCIR 601 camera interface 154, for example. The camera I/F 154 may also be used, for example, to connect the mobile multimedia processor 102 to a mobile TV front end.

The mobile multimedia processor 102 may also comprise a plurality of serial interfaces, such as the USB I/F 152, a serial peripheral interface (SPI) 157, and a universal asynchronous receiver/transmitter (UART) I/F 159 for Bluetooth or IrDA. The SPI master interface 157 may comprise suitable circuitry, logic, and/or code and may be utilized to control image sensors. Two chip selects may be provided, for example, and the interface may work in a polled mode with interrupts or via a DMA controller 163. In another embodiment of the invention, the interface may comprise an I2C serial interface, which may be used for camera control, for example. Furthermore, the mobile multimedia processor 102 may comprise a plurality of general purpose I/O (GPIO) pins 164, which may be utilized for user defined I/O or to connect to the internal peripherals. The display controller 162 may comprise suitable circuitry, logic, and/or code and may be adapted to support multiple displays with XGA resolution, for example, and to handle 8/9/16/18/24-bit video data.

The mobile multimedia processor 102 may be connected via an 8/16 bit parallel host interface 129 to the same bus as the baseband processing block 126 uses to access the baseband flash memory 124. The host interface 129 may be adapted to provide two channels with independent address and data registers through which a host processor may read and/or write directly to the memory space of the mobile multimedia processor 102. The baseband processing block 126 may comprise suitable logic, circuitry and/or code that may be adapted to convert RF signals to baseband and communicate the baseband processed signals to the mobile multimedia processor 102 via the host interface 129, for example. The RF processing block 130 may comprise suitable logic, circuitry and/or code that may be adapted to receive signals via the antenna 132 and to communicate RF or IF signals to the baseband processing block 126. The host interface 129 may comprise a dual software channel with a power efficient bypass mode.

The main LCD 134 may be adapted to receive data from the mobile multimedia processor 102 via a display controller 162 and/or from a second external memory interface 160, for example. The display controller 162 may comprise suitable logic, circuitry and/or code and may be adapted to drive an internal TV out function or be connected to a range of LCD's. The display controller 162 may be adapted to support a range of screen buffer formats and may utilize direct memory access (DMA) to access the buffer directly and increase video processing efficiency of the video processing cores 103A and 103B. Both NTSC and PAL raster formats may be generated by the display controller 162 for driving the TV out. Other formats, for example SECAM, may also be supported.

The display controller 162 may recognize and communicate a display type to the DMA controller 163. In this regard, the DMA controller 163 may fetch video data in an interlaced or non-interlaced fashion for communication to an interlaced or non-interlaced display coupled to the mobile multimedia processor 102 via the display controller 162.

The subsidiary LCD 136 may comprise suitable logic, circuitry and/or code that may be adapted to communicate with the mobile multimedia processor 102 via a second external memory interface 160, for example. The subsidiary LCD 136 may be used on a clamshell phone where the main LCD 134 may be inside and the subsidiary LCD 136 may be outside, for example. The mobile multimedia processor 102 may comprise a RGB external data bus. The mobile multimedia processor 102 may be adapted to scale image output with pixel level interpolation and a configurable refresh rate.

The optional flash memory 138 may comprise suitable logic, circuitry and/or code that may be adapted to communicate with the mobile multimedia processor 102 via an external memory interface 158, for example. The SDRAM 140 may comprise suitable logic, circuitry and/or code that may be adapted to receive data from the mobile multimedia processor 102 via the external memory interface 158, for example. The external memory I/F 158 may be utilized by the mobile multimedia processor 102 to connect to the SDRAM 140, SRAM, Flash memory 138, and/or external peripherals, for example. Control and timing information for the SDRAM 140 and other asynchronous devices may be configurable by the mobile multimedia processor 102.

The mobile multimedia processor 102 may further comprise a secondary external memory interface 160 to connect to memory-mapped LCD and external peripherals, for example. The secondary external memory interface 160 may comprise suitable circuitry, logic, and/or code and may be utilized to connect the mobile multimedia processor 102 to slower devices without compromising the speed of external memory access. The secondary external memory interface 160 may provide 16 data lines, for example, 6 chip select/address lines, and programmable bus timing for setup, access and hold times, for example. The mobile multimedia processor 102 may be adapted to provide support for NAND/NOR Flash including NAND boot and high speed direct memory access (DMA), for example.

In operation, the mobile multimedia processor 102 may be adapted to receive images or video from external cameras, such as cameras 120 and/or 122, and process the images via the video processors 103A and/or 103B, the ISP 103C and the 3D pipeline 103D. The video processing cores 103A and 103B may be integrated on a chip and may be located in regions of the chip with different power vs. performance characteristics. One section of the chip may comprise a higher percentage of higher threshold voltage CMOS transistors, resulting in lower leakage, which may be suitable for more efficient, lower power applications. These applications may comprise functions that may desirably be run on a constant or very frequent basis. Conversely, another section of the chip may comprise a higher percentage of lower threshold voltage CMOS transistors, for example, resulting in higher speed and higher leakage performance. This may be suitable for functions that run only occasionally, but may require high speed performance, such as image and/or video processing, for example.

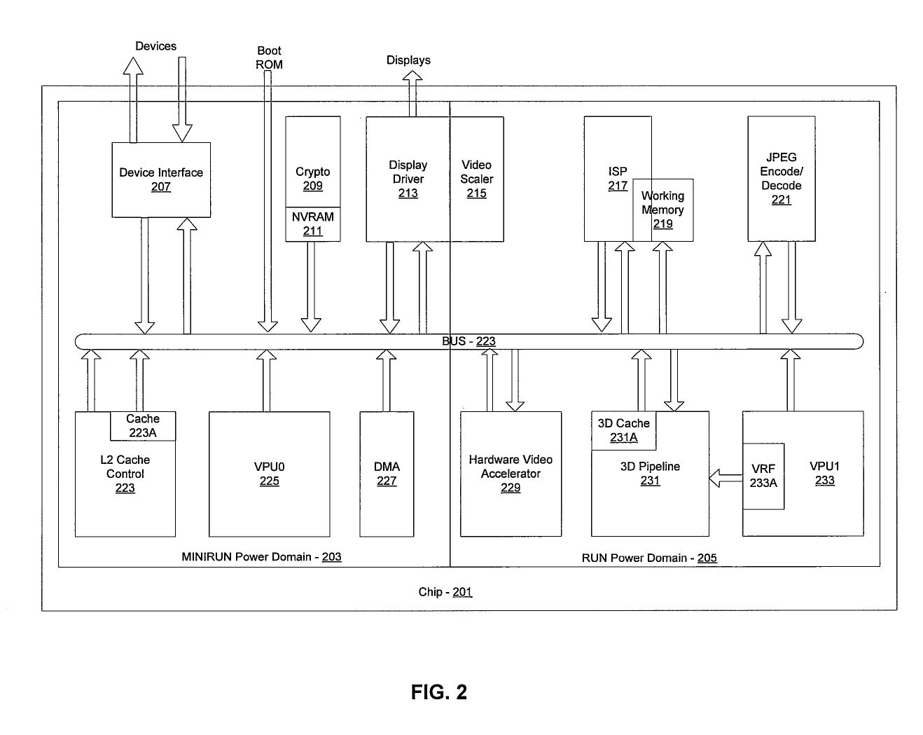

FIG. 2 is a block diagram of two vector processing units in different partitions on a chip, in accordance with an embodiment of the invention. Referring to FIG. 2, there is shown a chip 201 comprising a MINIRUN power domain 203 and a RUN power domain 205. A bus 223 may provide a channel for communication between the two domains and external devices. The bus 223 may comprise one or more busses to enable communication between peripherals, memory and L2 cache memory, for example.

The MINIRUN power domain 203 may comprise a device interface 207, a crypto block 209, a NVRAM 211, a display driver 213, a L2 cache control block 223, a cache memory 223A, a vector processing unit (VPU) VPU0 225 and a direct memory access (DMA) block 227. The MINIRUN power domain 203 may comprise a larger percentage of higher threshold voltage (V_{T}) CMOS transistors, as compared to the RUN power domain 205. The higher V_{T} transistors may have lower leakage currents than lower V_{T} transistors, and as such may be suitable for processes that may be constantly, or nearly constantly required. The RUN power domain 205 portion of the chip 201 may be disabled when functions performed by that section may not be needed, thus improving power efficiency.

The RUN power domain 205 may comprise a video scaler 215, an image sensor pipeline (ISP) 217, a memory 219, a JPEG encode/decode block 221, a hardware video accelerator (HVA) 229, a 3D pipeline 231 with a 3D cache memory 231A and a VPU1 233 with a vector register file 233A.

The device interface 207 may comprise suitable circuitry, logic and/or code that may enable interfacing external devices to the MINIRUN power domain 203 or the RUN power domain 205. The external device may comprise a host and/or double data rate (DDR) SDRAM, for example. The device interface 207 may be communicatively coupled to the bus 223 to allow communication to other components in the chip 201.

The crypto block 209 may comprise suitable circuitry, logic and/or code that may enable encrypting and/or decrypting data in the chip 201. The keys for the encrypting/decrypting may be stored in the non-volatile random access memory (NVRAM) 211.

The display driver 213 may comprise suitable circuitry, logic and/or code that may enable communicating image and/or video signals to a display. The display driver 213 may be communicatively coupled to the bus 223 for receiving signals to be communicated to a display. The display driver 213 and the video scaler 215 may comprise a common circuitry block, the display driver 213 part of which may reside in the MINRUN power domain 203, while the video scaler 215 part of which may reside in the RUN power domain 205. The video scaler 215 may be utilized to scale the image and/or video data size and aspect ratio to match the size and aspect ratio of the display that may be coupled to the display driver 213.

The L2 cache control block 223 may comprise suitable circuitry, logic and/or code that may enable control of the cache memory 223A. The cache memory may comprise high speed memory and may be utilized to store frequently used data for higher processing speeds by the VPU0 225 or the VPU1 233.

The VPU0 225 may comprise suitable circuitry, logic and/or code that may enable processing of data and the control of devices and peripherals communicatively coupled to the chip 201. The VPU0 225 may comprise a general purpose processor, for example, that may be capable of performing control operations as well as image sensor and 3D pipeline processing.

The DMA block 227 may comprise suitable circuitry, logic and/or code that may enable access to memory without utilizing the VPU0 225. In this manner, the speed of the system may be increased by reducing the processor usage and increasing the speed of memory access.

The ISP 217 may comprise suitable circuitry, logic and/or code that may enable processing of image data. The ISP 217 may comprise hardware and/or software implementations of filtering, demosaic, lens shading correction, defective pixel correction, white balance, image compensation, Bayer interpolation, color transformation, and post filtering, for example. The ISP 217 may have direct access to the working memory 219, which may be utilized as a buffer in the image pipeline during processing.

The JPEG encode/decode block 221 may comprise suitable circuitry, logic and/or code that may enable encoding and/or decoding of JPEG images, which may then be stored and/or displayed.

The HVA 229 may comprise suitable circuitry, logic and/or code that may enable encoding and decoding of video using MPEG-4 or H.264, for example, faster than would be possible with a processor only.

The 3D pipeline 231 may comprise suitable circuitry, logic and/or code that may enable processing of 3D data. The processing may comprise vertex processing, rasterizing, early-Z culling, interpolation, texture lookups, pixel shading, depth test, stencil operations and color blend, for example. The 3D pipeline 231 may also comprise the 3D cache 231A, which may be utilized to store data temporarily during processing, instead of communicating data outside of the 3D pipeline hardware to other memory blocks.

The VPU1 233 may be substantially similar to the VPU0 225, except that it may be located in a different region of the chip 201. Each processor VPU0 225 and VPU1 233 may be capable of performing the same tasks, but may have different speed and power performance. The VPU0 225 may be always on, whereas the VPU1 233 may only be switched on when needed, thus providing configurable speed and power usage in the chip 201.

In operation, the chip 201 may be utilized to receive image and/or video data from external sources via the bus 223. The 3D pipeline 231 may be utilized to process 3D images for display via the display driver 213. The ISP 217 may be utilized to process image data for display via the display driver 213.

The 3D pipeline 231 and the ISP 217 and associated components may reside on a portion of the chip 201 that may be powered up only when needed, such as for image and/or video processing, for example. Both portions of the chip 201, the MINIRUN power domain 203 and the RUN power domain 205 may comprise a vector processing unit, VPU0 225 and VPU1 233, respectively, that may be capable of controlling the required processes in the chip 201. In this manner, depending on the current status of the processors, a job may be performed by the most available processor. In instances where there may be no intensive image, 3D or video processing jobs, the RUN power domain 205 may be powered down to reduce power usage.

Functions performed by the VPU1 233 when controlling the 3D pipeline 231 may comprise pixel shading, working at the pixel level to do arbitrary shading programs which may comprise generating the colors. The VPU1 233 may also control vertex shading. Parameters may be generated for coloring the pixels rather than just transforming the vertices into screen space, which may comprise two aspects. One may comprise the transformation of all coordinates of vertices. 3D rendering space may be made up of polygons, which are typically triangles. The triangle may be made from vertices in a real world 3D space and then transformed into screen space. The 3D pipeline hardware may then fill in the triangle and interpolate the various parameters from across the vertices to determine how to color individual pixels, for texturing and coloring. Thus, the process may comprise vertex transformations and vertex shading calculations.

The VPU1 233 may perform other tasks when not working on 3D pipeline tasks, such as audio processing or video processing. Since the VPU1 233 may comprise a general purpose processor, it may perform general software processing tasks. In an embodiment of the invention, two VPUs 225 and 233 in separate partitions of the chip 201 may be utilized for configurable speed vs. power consumption performance, and may dynamically handle the processing of tasks based on the level of tasks to be performed, what other activities are taking place and the current processing load of each VPU 225 and 233. The VPUs 225 and 233 may be connected to the same SDRAM and therefore may cooperate on the distribution of tasks in the system via a mechanism known as Symmetric Multiprocessing (SMP). When running the VPUs 225 and 233 in SMP configuration, an intercore synchronization peripheral may be used to tightly couple the processors together. Some tasks may have an affinity to a particular processor such as the 3D pipeline 231 and therefore may not run on an arbitrary processor.

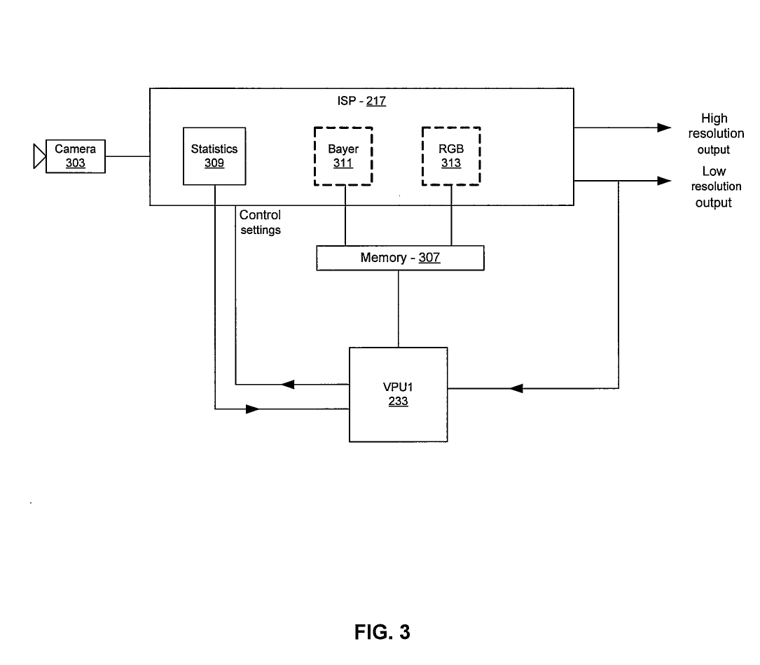

FIG. 3 is a block diagram illustrating an image sensor pipeline implementation process, in accordance with an embodiment of the invention. Referring to FIG. 3, there is shown a camera 303, the ISP 217, a memory 307 and the VPU1 233. The ISP 217 may comprise a set of pipeline stages comprising a statistic block 309, a Bayer software block 311 and an RGB software block 313, for example. The camera 303 may comprise a digital camera, digital video recorder or similar image capture device and may produce its output as Bayer data, for example. The ISP 217 may perform processing in the Bayer domain, then convert the image to RGB or YCbCr and perform additional processing in that domain. The memory 307 may comprise suitable circuitry, logic and/or code that may enable storing of data to be processed in the ISP 217.

The statistics block 309 may comprise suitable circuitry, logic and/or code that may enable monitoring of image statistics comprising dark pixel compensation, lens shading compensation and white balance and gain control, for example. The statistics block 309 may be communicatively coupled to the VPU1 233 for enabling control of the ISP 217 processes. The Bayer software block 311 may comprise suitable circuitry, logic and/or code that may enable the VPU1 233 to work in the ISP 217 on the Bayer data to perform a stage of the ISP 217 in software.

The RGB software block 313 may comprise suitable circuitry, logic and/or code that may enable the VPU1 233 to work in the ISP 217 on the RGB data to perform a stage of the ISP 217 in software such as color correction, gamma correction, YCbCr denoising and false color suppression, and/or other color processing.

In operation, image data may be generated by the camera 303 and communicated to the ISP 217. The statistics block 309 may determine the image statistics of the image. The measured statistics may be utilized by the VPU1 233 to control the various aspects of the processes in the ISP 217. Between each stage of the ISP 217, the processed data may be stored in the memory 307 temporarily before proceeding to the next stage. At any point in the ISP process, data may be fed into software stages running on the VPU1 233 using the Bayer and RGB software blocks 311 and 313. The output image data may be communicated from the low resolution output to the VPU1 233 for real-time image processing to segment the image, or identify aspects to focus on, for example, in the ISP 217.

Once the image has completed each stage of the ISP 217, the data may be output in either a high resolution output or a low resolution output, depending on the type of display to be used or the desired storage utilization.

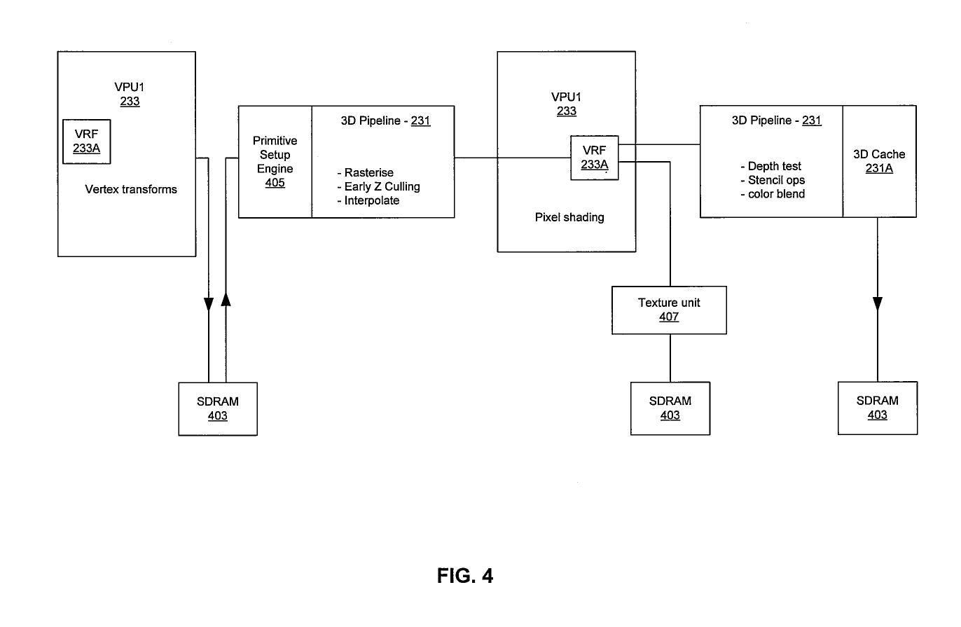

FIG. 4 is a block diagram of a 3D pipeline implementation process, in accordance with an embodiment of the invention. Referring to FIG. 4, there is shown the VPU1 233 and associated VRF 233A, a synchronous dynamic random access memory (SDRAM) 403, a primitive setup engine 405, the 3D pipeline 231 and associated 3D cache 231A and a texture unit 407.

The SDRAM 403 may comprise suitable circuitry, logic and/or code that may enable the storage of image data to be processed by the 3D pipeline 231. The primitive setup engine 405 may comprise suitable circuitry, logic and/or code that may enable processing of primitive shapes, such as triangles, for example, in the image data in preparation for 3D processing by the 3D pipeline 231. A triangle may comprise a primitive with an index of three, and the vertices, which are the coordinates and the parameters for a set of points.

The texture unit 407 may comprise suitable circuitry, logic and/or code that may enable access of textures stored in the SDRAM 403 and calculation of the texture data for a given pixel which may be used for pixel shading.

In operation, the VPU1 233 may initiate the processing of graphics data by the 3D pipeline 231. The VPU1 233 may perform vertex transforms on the data before storing in the SDRAM 403. The data may then be communicated to the primitive setup engine 405. For a primitive with index three, the primitive set up engine 405 may process a triangle by performing various calculations for processes in the 3D pipeline 232, such as interpolation, and also determines parameters for rasterizing the triangle, which may convert the primitive into pixels.

The parameters determined for a triangle by the primitive setup engine 405 may be communicated to the 3D pipeline 231, and may then start processing the next triangle. The 3D pipeline 231 may then rasterize and interpolate the first triangle, as well as perform early Z culling, which may comprise determining whether a particular pixel may be visible in the final image so that pixels that may not be visible may be discarded, thereby saving processor time and memory requirements in later processes.

The data may then be processed by the VPU1 233 where pixel shading may occur. The texture unit 407 may be utilized to do look ups for the texture. The texture results may be stored in the VRF 233A, a 2D mapping memory. As part of this processing, and what occurs in the VPU1 233, the coordinates may be determined for each pixel that may need to have its texture determined, the x,y position in the texture may be read out, and the color value for that textural element, may be read and written into the pixel.

In an embodiment of the invention, the VPU 233 and the 3D pipeline 231 may comprise a fully programmable architecture with hardware segments incorporated for selected 3D pipeline processing. This may result in smaller chip sizes and higher power efficiency, since the processor may be utilized for other purposes when not doing 3D processing, or may be powered down completely with other components in the RUN power domain 205, described with respect to FIG. 2. For example, the VPU1 233 may be utilized for vertex shading and/or pixel shading in the 3D pipeline, and then may be switched over to do audio or video processing.

In an embodiment of the invention, a method and system are provided for partitioning a device into partitions to optimize power consumption and may comprise partitioning circuitry within an integrated circuit 201 into a plurality of power domains 203 and 205, wherein each of the power domains 203 and 205 comprises different power consumption and power handling requirements and each of the power domains 203 and 205 comprises a processor 225 and 233. A processor 225 in a first of the power domains 203 may handle processing of tasks internal to the first of the power domains 203. A processor 225 in the first of the power domains may handle processing of tasks in a second of the plurality of power domains 205. The processor 225 and 233 in each of the plurality of power domains 203 and 205 may be communicatively coupled to one or more common busses 223 which may be shared by each of the plurality of power domains 203 and 205. A first of the power domains 203 may be powered in a continuous mode and may comprise low leakage circuitry. The processors 225 and 233 may comprise general purpose processors. A processor 233 in one of the plurality of power domains 205 may control image processing circuitry, which may comprise image sensor pipeline circuitry 217, 3D pipeline circuitry 231 and/or video accelerator circuitry 229.

In an embodiment of the invention, a method and system are provided for partitioning a device into partitions to optimize power consumption and may comprise partitioning the chip 201 into first and second power domains, 203 and 205, each power domain comprising a processor 225 and 233. The first power domain 203 may be powered in a continuous mode and may comprise low leakage circuitry. The second power domain 205 may comprise image processing circuitry, which may be controlled utilizing a processor 233 in the second power domain 205 or in some cases by the processor 225 in the first power domain 203. The processors 225 and 233 may comprise general purpose processors. The image processing circuitry may comprise image sensor pipeline circuitry 217, 3D pipeline circuitry 231 JPEG encode/decode circuitry 221, and/or video accelerator circuitry 229.

Certain embodiments of the invention may comprise a machine-readable storage having stored thereon, a computer program having at least one code section for data processing, the at least one code section being executable by a machine for causing the machine to perform one or more of the steps described herein.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for data processing, the method comprising:
partitioning circuitry within an integrated circuit into a plurality of power domains, wherein each of said plurality of power domains comprises different power consumption and power handling requirements and each of said plurality of power domains comprises a processor.

2. The method according to claim 1, comprising configuring a processor in a first of said power domains to handle processing of tasks internal to said first of said power domains.

3. The method according to claim 1, comprising configuring a processor in a first of said power domains to handle processing of tasks in a second of said plurality of power domains.

4. The method according to claim 1, wherein said processor in each of said plurality of power domains is communicatively coupled to one or more common busses which are shared by each of said plurality of power domains.

5. The method according to claim 1, comprising powering a first of said power domains in a continuous mode.

6. The method according to claim 5, wherein said first of said power domains comprises low leakage circuitry.

7. The method according to claim 1, wherein said processors comprise general purpose processors.

8. The method according to claim 1, comprising controlling image processing circuitry utilizing a processor in one of said plurality of power domains.

9. The method according to claim 8, wherein said image processing circuitry comprises image sensor pipeline circuitry.

10. The method according to claim 8, wherein said image processing circuitry comprises 3D pipeline circuitry.

11. The method according to claim 8, wherein said image processing circuitry comprises video accelerator circuitry.

12. A system for processing images, the system comprising:
one or more circuits that are partitioned within an integrated circuit into a plurality of power domains, wherein each of said plurality of power domains comprises different power consumption and power handling requirements and each of said plurality of power domains comprises a processor.

13. The system according to claim 12, wherein said one or more circuits comprise a processor in a first of said power domains that handle processing of tasks internal to said first of said power domains.

14. The system according to claim 12, wherein said one or more circuits enable configuring a processor in a first of said power domains to handle processing of tasks in a second of said plurality of power domains.

15. The system according to claim 12, wherein said processor in each of said plurality of power domains is communicatively coupled to one or more common busses which are shared by each of said plurality of power domains.

16. The system according to claim 12, wherein said one or more circuits enable powering a first of said power domains in a continuous mode.

17. The system according to claim 16, wherein said first of said power domains comprises low leakage circuitry.

18. The system according to claim 12, wherein said processors comprise general purpose processors.

19. The system according to claim 12, wherein said one or more circuits enable controlling image processing circuitry utilizing a processor in one of said plurality of power domains.

20. The system according to claim 19, wherein said image processing circuitry comprises image sensor pipeline circuitry.

21. The system according to claim 19, wherein said image processing circuitry comprises 3D pipeline circuitry.

22. The system according to claim 19, wherein said image processing circuitry comprises video accelerator circuitry.
